(19) United States
(12) Patent Application Publication
(10) Pub. No.: US 2021/0374366 A1
(43) Pub. Date: Dec. 2, 2021

(54) LOCATION SYSTEM AND METHOD FOR TRACKING INFECTED INDIVIDUALS

(71) Applicant: STANLEY CONVERGENT SECURITY SOLUTIONS, INC., Fishers, IN (US)

(72) Inventors: Reuven AMSALEM, Ness Ziona (IL); Talila Eti MILLMAN, Andover, MA (US); Iftach RECHT, Rehovot (IL); David MATZA, Ramat Gan (IL)

(21) Appl. No.: 17/329,692

(22) Filed: May 25, 2021

Related U.S. Application Data
(60) Provisional application No. 62/704,745, filed on May 27, 2020.

(51) Int. Cl. G06K 7/10

(52) U.S. Cl. CPC G06K 7/10366

(57) ABSTRACT

A location system with an RFID tag, first and second location receivers and a central server receiving information from at least one of the first and second location receivers. The system calculates the RFID tag's location. The system may include a short-range exciter. The short-range exciter transmits a low frequency signal, possibly at 125 kHz. The central server creates a record containing information when the multiple RFID tags were within close proximity. The RFID tags can provide an indication that they were within close proximity to each other, via audio signals and/or haptic vibrations.

### CROSS-REFERENCE TO RELATED APPLICATION

This application derives priority from U.S. Patent Application No. 62/704,745, filed on May 27, 2020, now pending, which is hereby incorporated in whole by reference.

### FIELD

The present invention relates to location systems, especially to so-called real time locations systems (RTLS), in which mobile wireless devices such as tags, transponders and/or mobile communications devices are located, and preferably tracked, by means of wireless signal transmissions.

### BACKGROUND

Location systems are used for locating, and preferably tracking, articles and/or people associated with respective wireless devices. Location systems are used in a wide range of environments, including hospitals and other healthcare situations, social care environments, prisons, industrial locations, warehouses, retail stores, educational institutions, offices and logistics environments, for example. Such systems may be used for locating and tracking patients (especially babies and the elderly) and other categories of people, and for locating and tracking medical supplies, equipment, products, tools and other categories of articles.

Location systems use one or more of a variety of wireless technologies, including wireless local area network (WLAN) technologies, wireless personal area network (WPAN) technologies (including low-rate wireless personal area network (LR-WPAN) technologies), radio frequency identification (RFID), ultra-wideband (UWB), cellular, satellite (e.g. global positioning system (GPS)), ultrasound, sound, infrared, visible light, camera vision, etc. Included in WLAN technologies are those conforming to the Institute of Electrical and Electronics Engineers (IEEE) 802.11 series of standards (e.g. Wi-Fi). Included in WPAN and LR-WPAN technologies are those conforming to the IEEE 802.15 series of standards (e.g. BlueTooth®, ZigBee®, etc.).

The mobile wireless devices which are located and tracked in location systems may, for example, be tags, transponders or mobile communications devices, and they may be active and/or passive. For example, active mobile wireless devices may function as “beacons” which periodically emit wireless signals indicating their presence. Passive mobile wireless devices may, for example, function as transponders, only emitting wireless signals in response to wireless signals emitted by wireless emitters of the location system. Some mobile wireless devices may function sometimes as passive devices and at other times as active devices. Depending upon their functionality, the mobile wireless devices may be self-powered (e.g. battery powered) or may obtain their power from the wireless signals emitted by wireless emitters of the location system. Mobile communications devices used in location systems include, for example: mobile (e.g. cellular) telephones, including smart phones; portable computer devices, e.g. tablet computers, laptop computers, handheld computers, personal digital assistants (PDAs), GPS devices; etc.

Location systems use a variety of techniques for calculating the locations of mobile wireless devices. For example, some location systems use the times at which wireless transmissions from mobile wireless devices are received (i.e., time-of-arrival (TOA) information), in order to calculate differences in times-of-arrival between different wireless receivers and to use the calculated time-difference-of-arrival (TDOA) information to calculate the locations of the mobile wireless devices. Alternatively, location systems may use received signal strengths (e.g. received signal strength indication (RSSI)), and/or angle of arrival (AOA) information, and/or round-trip time (RTT) information, radio map fingerprinting information, location information from nearby tags/transponders, satellite location information, etc. In some location systems the mobile wireless devices themselves perform at least part of the location calculations.

A typical location system for locating mobile wireless devices includes at least one wireless receiver (e.g. an access point) configured to receive wireless transmissions from the mobile wireless devices and to transmit (e.g. by wire or other physical conduit or wireless) bursts of device reports concerning the wireless transmissions to a report processor. Each wireless transmission from a mobile wireless device may include some or all of the following information: the identity of the mobile wireless device; the time (e.g. “time stamp”) of the wireless transmission; telemetry data (e.g. temperature, pressure, motion status, battery status, and/or other information concerning the mobile wireless device); and/or location information (for those devices which calculate, and/or obtain, information regarding their own location). Each burst of device reports comprises a one or more reports (i.e. data messages) concerning one or more wireless transmissions from a particular mobile wireless device. The wireless transmissions may be transmitted by the mobile wireless device on a plurality of channels, for example. The device reports may comprise any or all of the information which may be included in the wireless transmissions received from the mobile wireless devices and/or may comprise information concerning the wireless receiver (e.g. the identity and/or location of the wireless receiver) and/or may comprise information concerning the wireless transmissions which may be used to calculate the location of the mobile wireless device (e.g. the time(s) of arrival of the wireless transmissions, the received signal strength (e.g. RSSI), the angle of arrival, round-trip time information, radio map fingerprinting information, location information from nearby tags/transponders, satellite location information, etc.).

The report processor may, for example, be a so-called “location engine”, i.e. a processor configured to receive the device reports and to use them to calculate the location of the mobile wireless device(s). The report processor may be configured to receive the bursts of device reports from the wireless receivers during burst reception time windows.

Another typical location system for locating mobile wireless devices includes at least one wireless transmitter (e.g. an access point or other type of wireless transmitter) configured to transmit wireless transmissions (e.g. beacons) to be received by the mobile wireless devices. The wireless messages received by the mobile devices may be measured (e.g. TOA, RSSI, AOA) and the measurement results wirelessly transmitted to a report processor together with other information. Thus, each wireless transmission from a mobile wireless device may comprise some or all of the following information: the identity of the mobile wireless device; the time (e.g. “time stamp”) of the wireless transmission; telemetry data (e.g. temperature, pressure, motion status, battery status, and/or other information concerning the mobile wireless device); location information (for those devices which calculate, and/or obtain, information regarding their own location); and/or information concerning the received wireless transmissions which may be used to calculate the location of the mobile wireless device (e.g. the time(s) of arrival of the wireless transmissions, the received signal strength (e.g. RSSI), the angle of arrival, round-trip time information, radio map fingerprinting information, location information from nearby tags/transponders, satellite location information, etc.).

The mobile device wireless transmission sent to the report processor may be organized in bursts where each burst comprises one or more reports (i.e. data messages) concerning one or more wireless messages received from one or more beacon device. The wireless transmissions in a burst may be transmitted by the mobile device on a plurality of channels, for example.

The device reports may comprise any or all of the information which may be included in the wireless transmissions received from the wireless transmitter and/or may comprise information concerning the wireless transmitter (e.g. the identity and/or location of the wireless transmitter), the transmission power, the transmission channel, etc.

The report processor may, for example, be a so-called “location engine”, i.e. a processor configured to receive the device reports and to use them to calculate the location of the mobile wireless device(s). The report processor may be configured to receive the bursts of device reports from the wireless mobile device during burst reception time windows.

### BRIEF DESCRIPTION OF THE DRAWINGS

The novel features believed characteristic of the invention are set forth in the appended claims. The invention itself, as well as a preferred mode of use, and advantages thereof, will best be understood by reference to the following detailed description of illustrated embodiments when read in conjunction with the accompanying drawings, wherein like reference numerals and symbols represent like elements.

FIG. 1 is a diagram showing elements of a location system deployed across an exemplary single-floor map.

FIG. 2 is a diagram showing elements of a location system deployed across an exemplary multiple-floor map.

FIG. 3 shows a block diagram of components within an RFID tag.

FIG. 4 is a flowchart of a method for assigning confidence values to possible contacts.

### DESCRIPTION OF PREFERRED EMBODIMENT

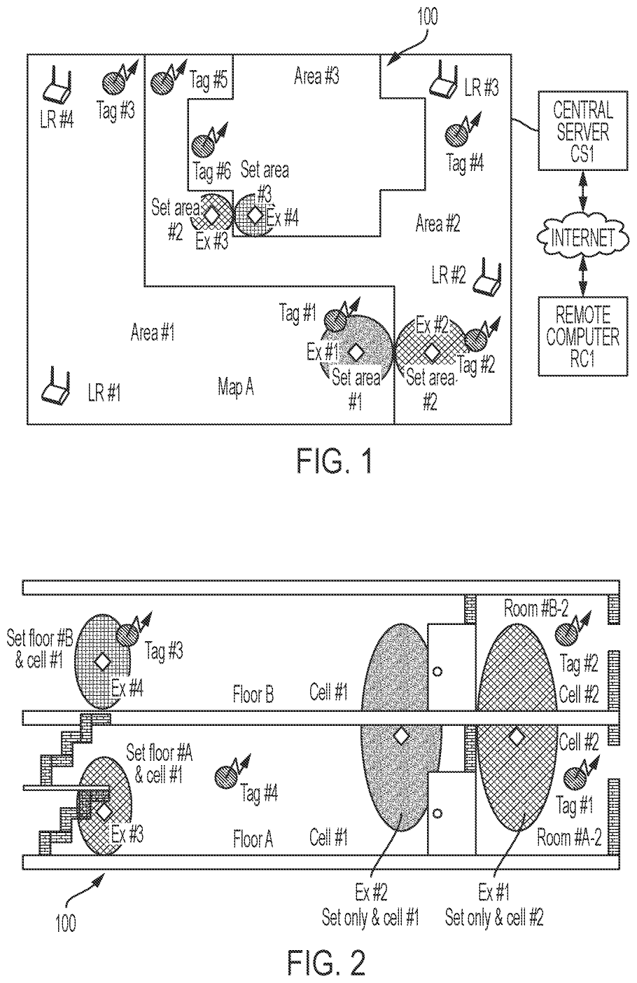

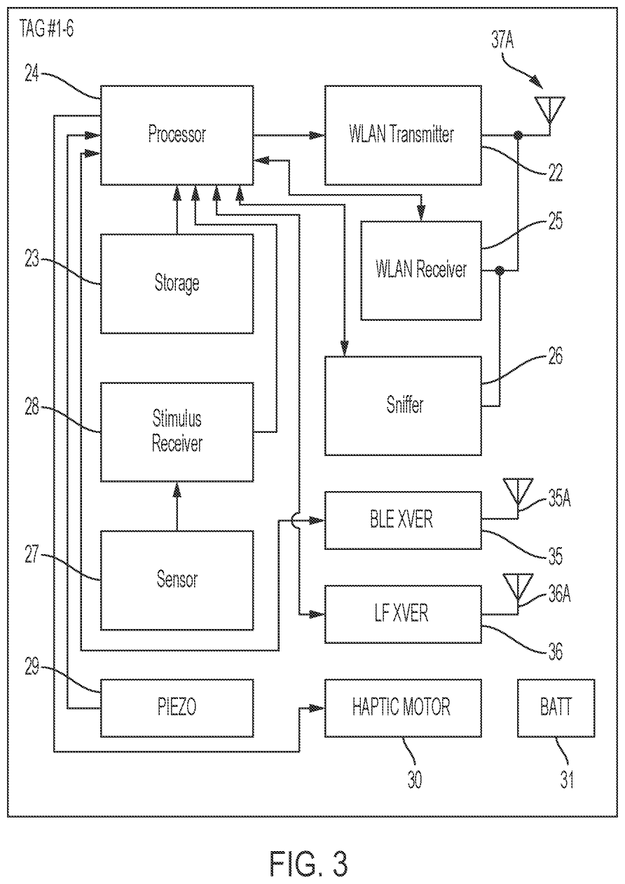

Referring to FIG. 1, a location system 100 installed in a multi-area defined as map #A is shown. The multi-area (map #A) may include three well defined areas Area #1, Area #2, Area #3. The perimeters of each of the areas Areas #1-#3 may be limited by walls, shown as black lines in FIG. 1. Movement between the different areas Areas #1-#3 may be done through doors which are shown as openings in the walls in Map #A (e.g., between Areas #1 and #2 in the right bottom corner and between Areas #2 and #3 in the center of the picture).

Location system 100 may have multiple location receivers LR#1, LR#2, LR#3, LR#4 throughout multi-area (map #A). Persons skilled in the art shall recognize that the following description of the preferred embodiments refers to location receivers but it shall be understood that it also applies to other units such WLAN access points, RFID receivers, etc. performing location in a WLAN network or any other wireless communication network.

Location system 100 may also have multiple RFID tags (Tag#1, Tag#2, Tag#3, Tag#4, Tag#5, Tag#6) carried by individuals and/or attached to equipment. Referring to FIG. X, RFID tags Tags#1-#6 may include a transmitter 22 that transmits signals originated by a processor 24 via an antenna 37A. RFID tags Tags#1-#6 may transmit periodically at predetermined intervals a signal that includes its MAC address or other identifier(s) retrieved from storage 23, which may also store processor 24 instructions and data. RFID tags Tags#1-#6 optionally include a receiver 25 for receiving signals from location receivers LR#1, LR#2, LR#3, LR#4 and/or other components of the location system 100.

Receiver 25 is preferably coupled to processor 24 for providing received data and command information to processor 24 and for receiving control information from processor 24. Processor 24 may control a power state of receiver 26, so that receiver 26 is only powered-up when desirable. As an alternative to periodic transmission of presence signals, a stimulus receiver 28 may detect the presence of an external stimulus via a sensor 27.

Sensor 27 may for example be a low-frequency magnetic field detector of a type generally used to activate standard non-WLAN RFID tags or passive re-radiating tags when brought proximate an external exciter. Sensor 27 may also be an infrared or ultrasound sensor that provides added security for presence detection and/or location-finding by activating transmission of the presence signal only in response to a local infrared or ultrasound communication from another device in the location system 100.

A sniffer circuit 26 may also be provided to control when the signals are transmitted by RFID tags Tags#1-#6, so that such signals are only transmitted when no other signals are being transmitted within location system 100, thus reducing the chance of collisions and providing timing for powering up receiver 25 to receive command and control information in battery operated applications such as tags, and/or to activate signal transmissions only when a location system 100 is detected via detecting that message traffic is occurring over a longer time interval. Persons skilled in the art shall recognize that sniffer 26 may first detect that RFID tags Tags#1-#6 is in the presence of a location system 100, and then determines when the location system 100 is momentarily silent before transmitting any signals.

Tags#1-#6 may include a Bluetooth transmitter/receiver 35 that transmits signals originated by processor 24 via an antenna 35A. Persons skilled in the art shall recognize that the Bluetooth transmitter/receiver 35 can have separate transmitter and receiver modules, or be combined into a transceiver circuit. Preferably, the Bluetooth transmitter/receiver 35 shall transmit signals in the Bluetooth low energy (BLE) communication protocol.

Tags#1-#6 may include a low frequency (LF) transmitter/receiver 36 that transmits signals originated by processor 24 via an antenna 36A. Persons skilled in the art shall recognize that the LF transmitter/receiver 36 can have separate transmitter and receiver modules, or be combined into a transceiver circuit. Preferably LF transmitter/receiver 36 transmits and/or receives signals with a frequency between 30 KHz and 300 KHz (preferably around 125 KHz-134 KHz). Such signals may contain the transmitter's MAC address or ID, as well as additional transmitter information.

Tags#1-#6 preferably have a piezoelectric speaker 29 that can generate at least one tone and/or tone pattern as instructed by processor 24. Tags#1-#6 may have a haptic motor 30 that can generate at least one vibration pattern as instructed by processor 24.

Persons skilled in the art shall recognize that Tags#1-#6 preferably have a battery 31 for powering the different component described above. Having a battery 31 power LF transmitter/receiver 36 will ensure that the generated LF signals can travel farther than if Tags#1-#6 were powered passively by incoming radio signals.

Location system 100 may locate the transmitter tags Tags#1-6 in within multi area map #A. Location receivers LR#1 and LR#4 may receive a wireless message signal from RFID tag Tag#3. Location receivers LR#1 and LR#4 may calculate the location of RFID tag Tag#3 by measuring RSSI, TOA, TDOA or any other commonly used wireless location method. Alternatively, location receivers LR#1 and LR#4 may send the received message and/or additional RSSI/TOA/TDOA information to a central server CS1, which would then use the information to calculate the location of RFID tag Tag#3 within multi area map #A. Persons skilled in the art are referred to U.S. Pat. Nos. 9,632,898, 7,522,049 and 7,403,108, and Patent Publication No. US2016100289, all of which are incorporated herein by reference, for further information on commonly used wireless location methods.

Once the location of RFID tag Tag#3 is calculated, central server CS1 can then send the location information of RFID tag Tag#3 to a remote computer RC1 for display of its location within multi area map #A. Such information can be sent to remote computer RC1 via the internet, preferably through a cloud computing system.

Location system 100 may also include short range RFID transmitters or exciters EX#1, EX#2, EX#3, EX#4. Preferably, the exciters EX#1-EX#4 are low frequency (125 KHz) exciters with a short range of up to few meters. It is preferable to provide a pair of exciters (e.g., EX#1-EX2) on each side of a door. Persons skilled in the art shall recognize that transmitters EX#1-EX#4) may transmit at other frequencies (ultrasound, HF, VHF and UHF bands) without departing from the spirit and scope of the present invention.

Each exciter EX#1-EX#4 may continuously broadcasts messages which include among other parameters their transmitter ID and an area ID. For example exciter EX#1 and EX#4 transmit a message effectively stating that it is respectively located in Area #1 and Area #4, while exciters EX#2 and EX#3 each transmits a message effectively stating that it is located in Area #2.

As such, an RFID tag (Tag #1-#6) which is in the coverage range of one of the exciter (EX#1-EX#4) receives the corresponding area ID which is subsequently transmitted in every tag message. Accordingly, RFID tag Tag #1 which is in the coverage area of exciter EX#1 is programmed to transmit in its messages that it is effectively located at Area #1. Similarly, RFID tag Tag #2 which is in the coverage area of exciter EX#2 will transmits in all its messages that it is effectively located at Area #2.

RFID tag Tag#3 however will transmit in its messages that it is effectively located at Area #1, even though it is not in the coverage area of any of the exciters EX#1-EX#4, since this was the last programmed area for this specific tag Tag#3. Similarly, RFID tags Tags #4-#5 will transmit that it is effectively located at Area #2, RFID tag Tag #6 will transmit that it is effectively located at Area #3. Persons skilled in the art will note that it is not important how the RFID tags Tags #1-#6 move between the areas (Areas #1-#3), as each tag will include the last programmed area in its transmitted message(s). Persons skilled in the art will recognize that, with such implementation, location system 100 will have full and absolute area differentiation even when the RFID tag is not anymore in the coverage range of the exciters EX#1-EX#4.

In other preferred embodiments the concept of area ID is enhanced to consist of several hierarchical layers (e.g. map and cell, floor and room, building, floor and room). In this preferred embodiment, an exciter can program an RFID tag to send message transmissions with some or all of those layer identifiers (e.g. floor only, room only, floor and room or any combination thereof).

Such methodology can be used to calculate the location of an RFID tag in a multi-level structure. FIG. 2 illustrates a two floor building, each floor consisting of a general area called cell#1 and a closed room called cell#2. For example, Room #A-2 is Cell#2 in Floor A, while Room #B-2 is Cell #2 in Floor B. The movement between the floors is done through the staircase on the right side of each floor.

In this preferred embodiment four exciters EX#1-EX#4 are installed. Exciters

EX#1 and EX#2 may be installed in a way that their coverage area includes both floors. Thus, an RFID tag entering into room A-2 or room B-2 is captured by exciter EX#1. Exciter EX#1 would program the RFID tag to send messages effectively stating that it is located in cell #2, with the previously stored floor information, i.e., without altering the previously stored floor information. Thus RFID tag Tag#1 in room A-2 will transmit floor #A and cell #2 while Tag #2 will transmit floor #B and cell #2.

As the RFID tag enters room A-1 or room B-1 from room A-2 or room B-2, respectively, such movement is captured by exciter EX#2. Exciter EX#2 would program the RFID tag to send messages effectively stating that it is located in cell #2, with the previously stored floor information, i.e., without altering the previously stored floor information.

In this preferred embodiment, an RFID tag moving from floor to floor will be programmed on the staircase and it will transmit the floor information that was last programmed. In other words, as the RFID tag however approaches exciter EX#3 and/or EX#4, the RFID tag would be programmed to transmit a message containing the cell information (cell #1) with the updated floor information (Floor A for exciter EX#3, Floor B for exciter EX#4).

It should be noted that the exciters EX#1-EX#4 can also be located in the proximity of elevators, passages, staircases or any desired combination.

In other preferred embodiments, different exciters can be used to cover cells in different floors. In other preferred embodiments, cells or areas may or may not overlap, exciters can be installed in and/or in the proximity of more than one entrance or exit to a specific area, cell or floor and tags can be configured as required by the application.

In addition, exciters can be programmed by the location system to dynamically change the broadcasted message to the tags. In this preferred embodiment, the areas or cells can be changed dynamically during system operation, thus achieving flexible definition of areas according to the application needs.

With either embodiment, location system 100 can be used to track contact between two individuals. In particular, as location system 100 calculates and tracks the locations of RFID tags Tags#1-6, location system 100 may also keep track of the occasions when RFID tags Tags#1-6 came within a short distance of each other. If RFID tags Tags#1-6 are carried by individuals, such events can be listed as possible contacts. Such possible contacts are preferably time-stamped, i.e., location system 100 can include in the contact record the time of when such possible contact occurred. Location system 100 can generate a report listing all the possible contacts between individuals for a particular time period.

Such capability enables tracking possible contact between possibly infected individuals. By tracking all the individuals that were within close proximity of each other, it is easier to determine which individuals need to be contacted concerning possible infection.

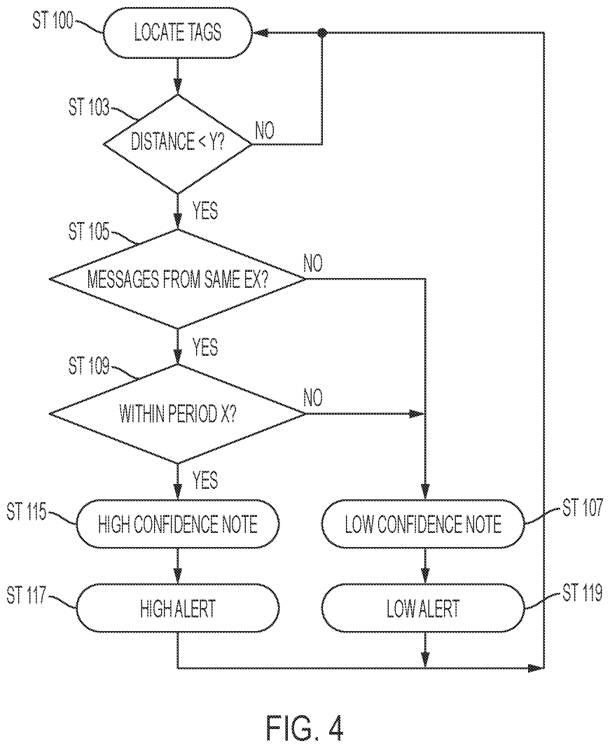

The contact record may also include a confidence value for each possible contact. FIG. 4 illustrates a method for determining the confidence value of such contacts. As stated above, location system 100 calculates the location of each individual RFID tags Tags#1-6 (ST100). Location system 100 analyzes whether the calculated position of two tags, e.g., Tags#1-2, are within a predetermined distance range Y (ST103). The distance range Y between tags can be up to 4 meters, and preferably up to 2 meters.

Alternatively (or in addition), Tags#1-2 may determine they are in close proximity to each other without assistance of central server CS1. In particular Tag#1 may transmit BLE advertisement messages on a periodic basis for a period of time (e.g., every 100 ms for 900 ms) via the Bluetooth transmitter/receiver 35 and switch to receiving mode (e.g., for 100 ms). Persons skilled in the art shall recognize allowing Tag#1-#6 to switch between transmitting and receiving modes, allows the tags to receive BLE advertisements from other tags and enables the other tags to receive the BLE advertisements transmitted by the message-originating tag. When a tag receives an advertisement message, the tag estimates the distance from the other tag based on Received Signal Strength Indicator (RSSI) based techniques.

Similarly, Tag#1 could send a message via the LF transmitter 36. Other tags that receive the LF message are thus within predetermined distance range Y as the range setting (or RSSI threshold) can be configured by Tag#1 or by location system 100.

If the distance is within the predetermined distance range Y, the tag can send a unidirectional Wifi or BLE message to central server CS1 of the possible contact. The tag can also store information of the possible contact in its storage 23. Such information may include the identity of the other tag, the related RSSI information, the time when the possible contact began, the time when the possible contact ended, etc.

The location system 100 may then check whether Tags#1-2 received a message from the same exciter (ST105). If not, then location system 100 adds the contact between the two tags as a possible contact with a low confidence value to the contact list (ST107).

However, if Tags#1-2 received a message from the same exciter, the location system 100 preferably checks whether the messages received from Tags#1-2 from the same exciter were received within time period X (ST109). Preferably time period X is below 10 minutes and preferably below 5 minutes.

If such messages were received within time period X, location system 100 adds the contact between the two tags as a possible contact with a high confidence value to the contact list (ST115). Otherwise, location system 100 adds the contact between the two tags as a possible contact with a low confidence value to the contact list (ST107).

If Tags#1-#6 have a piezoelectric speaker 29 and/or a haptic motor 30, location system 100 can instruct processor 24 to activate piezoelectric speaker 29 and/or haptic motor 30 when a possible contact between 2 tags is calculated. Accordingly, individuals wearing these tags will get a sound and/or vibration alert from their tag that another tag is in close proximity to them. Preferably, piezoelectric speaker 29 may generate multiple tones or tone patterns. Similarly, haptic motor 30 may generate multiple vibration patterns. Location system 100 can then activate a particular tone/tone pattern and/or vibration pattern for possible contacts with high confidence value (ST117) and a different tone/tone pattern and/or vibration pattern for possible contacts with low confidence value (ST119).

Location system 100 continues monitoring the tag locations, and notes when the close proximity between Tags#1-#2 ends. Location system 100 can store in its memory the tags involved in the possible contact, as well as the length of the possible contact.

While the invention has been particularly shown and described with reference to preferred embodiments thereof, it will be understood by those skilled in the art that the foregoing and other changes in form and details may be made therein without departing from the spirit and scope of the invention.

What is claimed is:

1: A location system comprising:
a first RFID tag transmitting a signal with an identifying characteristic;
first and second location receivers, wherein at least one of the first and second location receivers receives the signal from the first RFID tag; and
a central server receiving information from at least one of the first and second location receivers, at least one of the central server and the first and second location receivers to calculating a location of the first RFID tag based on the signal received from the first RFID tag by the at least one of the first and second location receivers.

2: The location system of claim 1, wherein the first RFID tag transmits a MAC address.

3: The location system of claim 1, further comprising a first short-range exciter transmitting a message representative of its location, said message being receivable by the first RFID tag;

4: The location system of claim 3, wherein the first short-range exciter transmits a low frequency signal.

5: The location system of claim 4, wherein the low frequency signal has a frequency of 125 kHz.

6: The location system of claim 3, wherein the first RFID will transmit a message indicating proximity to the first short-range exciter upon receipt of the message from the first short-range exciter.

7: The location system of claim 3, wherein the message transmitted by the first short-range exciter has information representative of at least one of the building, floor and room in which the first short-range exciter is located.

8: The location system of claim 3, further comprising a second RFID tag.

9: The location system of claim 8, wherein the central server creates a record containing information when the first and second RFID tags were within close proximity.

10: The location system of claim 9, wherein the central server checks whether the first and second RFID tags received a message from the first short-range exciter.

11: The location system of claim 10, wherein the central server updates the record to denote a high confidence value that the first and second RFID tags were within close proximity.

12: The location system of claim 8, wherein the first and second RFID tags provide an indication that the first and second RFID tags were within close proximity to each other.

13: The location system of claim 12, wherein the indication is at least one of an audio and a haptic vibration.
